(19) United States
(12) Patent Application Publication
(10) Pub. No.: US 2026/0217210 A1
(43) Pub. Date: Jul. 30, 2026

(54) AIRBAG APPARATUS

(71) Applicant: HYUNDAI MOBIS CO., LTD., Seoul (KR)

(72) Inventors: Sang Won HWANGBO, Yongin-si (KR); Dong Gil LEE, Yongin-si (KR)

(73) Assignee: HYUNDAI MOBIS CO., LTD., Seoul (KR)

(21) Appl. No.: 19/387,995

(22) Filed: Nov. 13, 2025

(30) Foreign Application Priority Data
Jan. 24, 2025 (KR) 10-2025-0011287

(51) Int. Cl. B60R 21/2338; B60R 21/207; B60R 21/233; B60R 21/235

(52) U.S. Cl. CPC B60R 21/2338; B60R 21/207; B60R 21/233; B60R 21/235; B60R 2021/23308; B60R 2021/23386; B60R 2021/23538

(57) ABSTRACT

An airbag apparatus including a first chamber including a first side cushion connected to a first side of a seatback included in a vehicle seat and deployed forward, and a first front cushion deployed from the first side cushion to face a front of an occupant, a second chamber including a second side cushion connected to a second side of the seatback and deployed forward, and a second front cushion deployed from the second side cushion in front of the first front cushion so as to overlap the first front cushion, and a first surface tether having a first side coupled to the second side cushion and a second side coupled to the second front cushion, and be positioned above the first chamber when the first chamber and the second chamber are deployed.

### CROSS-REFERENCE TO RELATED APPLICATION

The present application claims priority and the benefit of Korean Patent Application No. 10-2025-0011287, filed on January 24, 2025, in the Korean Intellectual Property Office, the entire disclosure of which is incorporated herein by reference.

### BACKGROUND

### FIELD

The present disclosure relates to an airbag apparatus, and more particularly, to an airbag apparatus that is deployed to surround an occupant in the event of a collision.

### DESCRIPTION OF THE RELATED ART

As autonomous driving technology advances, seats are installed in various positions and orientations within a passenger cabin. Accordingly, a so-called surround airbag is required, which is installed in the seat and deploys cushions to surround an occupant in the event of a vehicle collision, so that the occupant seated on the seat may be protected regardless of the seat's installation position or orientation.

The related art of the present disclosure is disclosed in Korean Patent Application Publication No. 10-2019-0028588 (published on March 19, 2019 and entitled "AIR BAG DEVICE FOR VEHICLE").

### SUMMARY

Exemplary embodiments of the present disclosure are directed to providing an airbag apparatus in which a pair of chambers protrude from both sides of a seatback to surround an occupant, and front cushions of the pair of chambers precisely overlap and are firmly coupled.

An airbag apparatus according to the present disclosure includes a first chamber including a first side cushion connected to a first side of a seatback included in a vehicle seat and configured to be deployed forward, and a first front cushion configured to be deployed from the first side cushion to face a front of an occupant, a second chamber including a second side cushion connected to a second side of the seatback and configured to be deployed forward, and a second front cushion configured to be deployed from the second side cushion in front of the first front cushion so as to overlap the first front cushion, and a first surface tether configured to have a first side coupled to the second side cushion and a second side coupled to the second front cushion, and be positioned above the first chamber when the first chamber and the second chamber are deployed.

The first side of the first surface tether may be coupled to an upper portion of the second side cushion, and the second side of the first surface tether may be coupled to an upper portion of the second front cushion.

The second side cushion may include an outer side cushion sheet, an inner side cushion sheet superimposed on the outer side cushion sheet, and a side cushion stitched portion that couples an outer periphery of the outer side cushion sheet and an outer periphery of the inner side cushion sheet, and the second front cushion may include an outer front cushion sheet, an inner front cushion sheet superimposed on the outer front cushion sheet, and a front cushion stitched portion that couples an outer periphery of the outer front cushion sheet and an outer periphery of the inner front cushion sheet, wherein the airbag apparatus may further include a first surface tether rear stitched portion that couples an outer region of the second side cushion, outside the side cushion stitched portion, and the first side of the first surface tether, and a first surface tether front stitched portion that couples an outer region of the second front cushion, outside the front cushion stitched portion, and the second side of the first surface tether.

The length of the first surface tether front stitched portion may range from one-third to one times the length of the second front cushion.

Of the two longitudinal ends of the first surface tether front stitched portion, the distance between one end closer to the second side cushion and the longitudinal centerline of the second side cushion may range from zero to one-tenth of the length of the second front cushion.

The extension line of the first surface tether front stitched portion and the extension line of the first surface tether rear stitched portion may be perpendicular.

The planar shape of the first surface tether may be triangular or trapezoidal.

The airbag apparatus may further include a second surface tether configured to have one side coupled to the second side cushion and the other side coupled to the second front cushion, be positioned spaced apart from the first surface tether, and be positioned below the first chamber when the first chamber and the second chamber are deployed.

The first side of the second surface tether may be coupled to a lower portion of the second side cushion, and the second side of the second surface tether may be coupled to a lower portion of the second front cushion.

The second side cushion may include an outer side cushion sheet, an inner side cushion sheet superimposed on the outer side cushion sheet, and a side cushion stitched portion that couples an outer periphery of the outer side cushion sheet and an outer periphery of the inner side cushion sheet, and the second front cushion may include an outer front cushion sheet, an inner front cushion sheet superimposed on the outer front cushion sheet, and a front cushion stitched portion that couples an outer periphery of the outer front cushion sheet and an outer periphery of the inner front cushion sheet, wherein the airbag apparatus may further include a second surface tether rear stitched portion that couples an outer region of the second side cushion, outside the side cushion stitched portion, and the first side of the second surface tether, and a second surface tether front stitched portion that couples an outer region of the second front cushion, outside the front cushion stitched portion, and the second side of the second surface tether.

The length of the second surface tether front stitched portion may range from one-third to one times the length of the second front cushion.

Of the two longitudinal ends of the second surface tether front stitched portion, the distance between one end closer to the second side cushion and the longitudinal centerline of the second side cushion may range from zero to one-tenth of the length of the second front cushion.

The extension line of the second surface tether front stitched portion and the extension line of the second surface tether rear stitched portion may be perpendicular.

The planar shape of the second surface tether may be triangular or trapezoidal.

The airbag apparatus may further include a front cushion coupling portion configured to detachably couple the first front cushion and the second front cushion when the first front cushion and the second front cushion overlap.

In the airbag apparatus, when the first chamber and the second chamber are deployed, the first front cushion and the second front cushion precisely overlap, and the front cushion coupling portion is firmly and reliably coupled to prevent separation of the first chamber and the second chamber. Accordingly, in the event of a vehicle collision, the first chamber and the second chamber are prevented from separating, thereby safely restraining the occupant and preventing serious injury to the occupant.

### BRIEF DESCRIPTION OF THE DRAWINGS

FIG. 1 is a perspective view illustrating a state in which an airbag apparatus according to an embodiment of the present disclosure is deployed to surround an occupant.

FIG. 2 is a plan view illustrating a state in which an airbag apparatus according to an embodiment of the present disclosure is deployed to protrude from a seatback as viewed from above.

FIG. 3 is a bottom view illustrating a state in which an airbag apparatus according to an embodiment of the present disclosure is deployed as viewed from below.

FIG. 4 is a development view illustrating an outer side cushion sheet, an inner side cushion sheet, and a side cushion stitched portion included in a second side cushion of FIG. 2 in an unfolded state.

FIG. 5 is a development view illustrating an outer front cushion sheet, an inner front cushion sheet, and a front cushion stitched portion included in a second front cushion of FIG. 2 in an unfolded state.

FIG. 6 is a development view illustrating a state in which the second side cushion and the second front cushion included in a second chamber of FIG. 2 are coupled to each other in an uninflated state, and a first surface tether and a second surface tether are separated from the second side cushion and the second front cushion.

FIG. 7 is an enlarged view illustrating portion A of FIG. 6.

FIG. 8 is an enlarged view illustrating portion B of FIG. 6.

FIG. 9 is an enlarged view illustrating portion C of FIG. 6.

FIG. 10 is an enlarged view illustrating portion D of FIG. 6.

### DETAILED DESCRIPTION

Embodiments of an airbag apparatus according to the present disclosure will be described below with reference to the accompanying drawings. The terminology used herein is intended to appropriately describe preferred embodiments of the present disclosure, and may vary depending on the intentions of the user or operator or the conventions of the field to which the present disclosure pertains. Therefore, the definition of the terminology should be made according to the overall disclosure set forth herein.

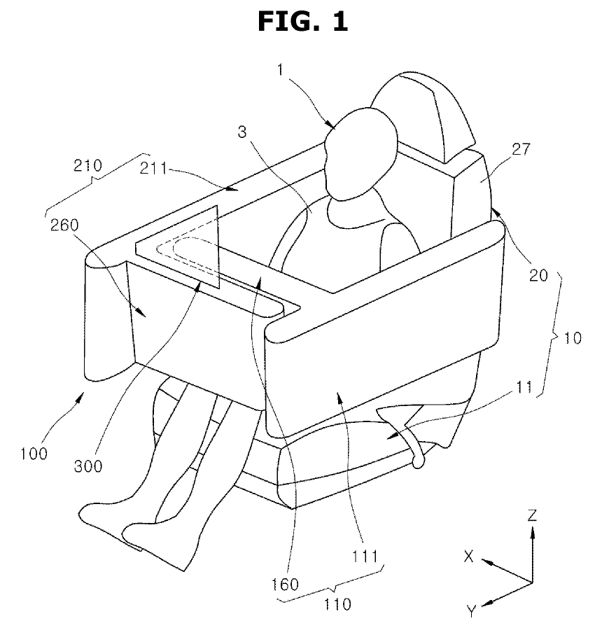

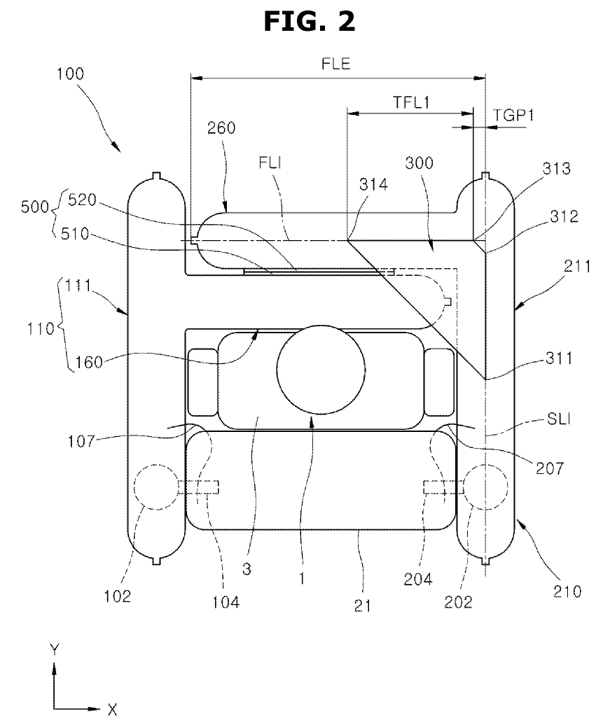

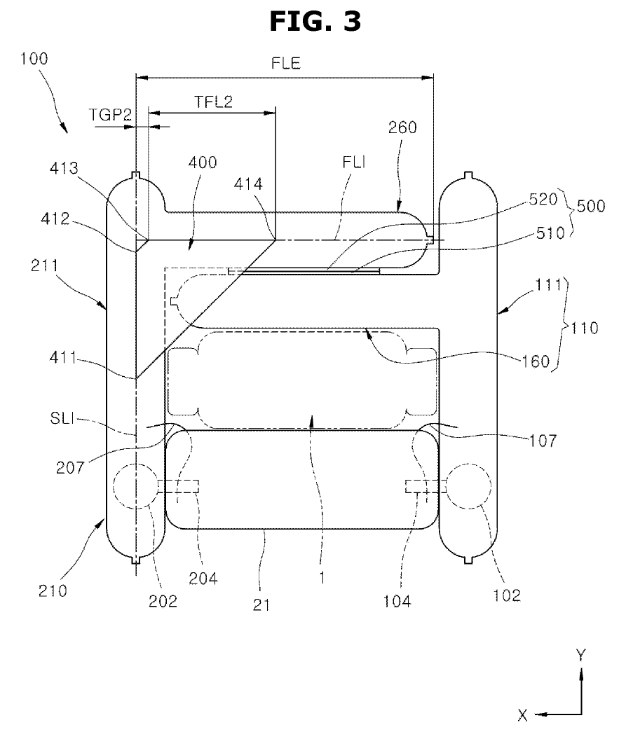

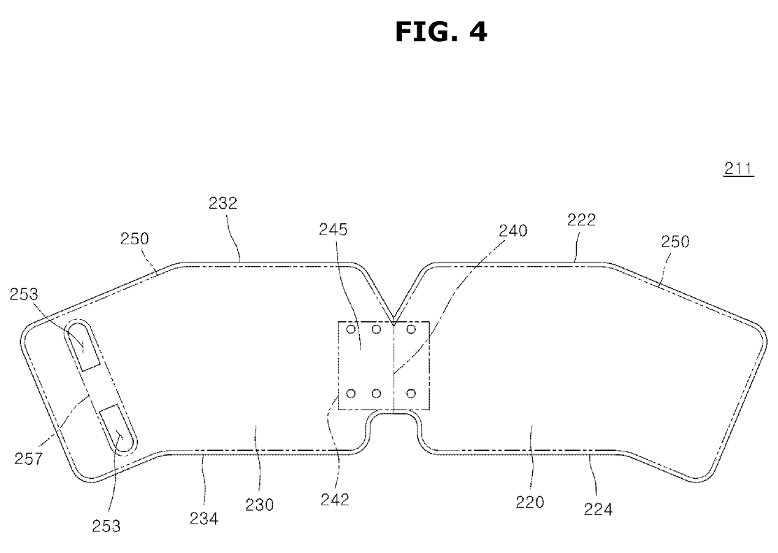

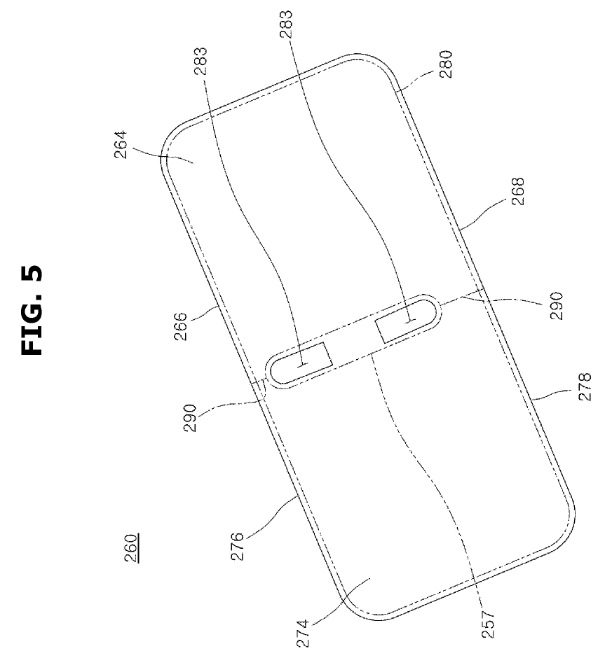

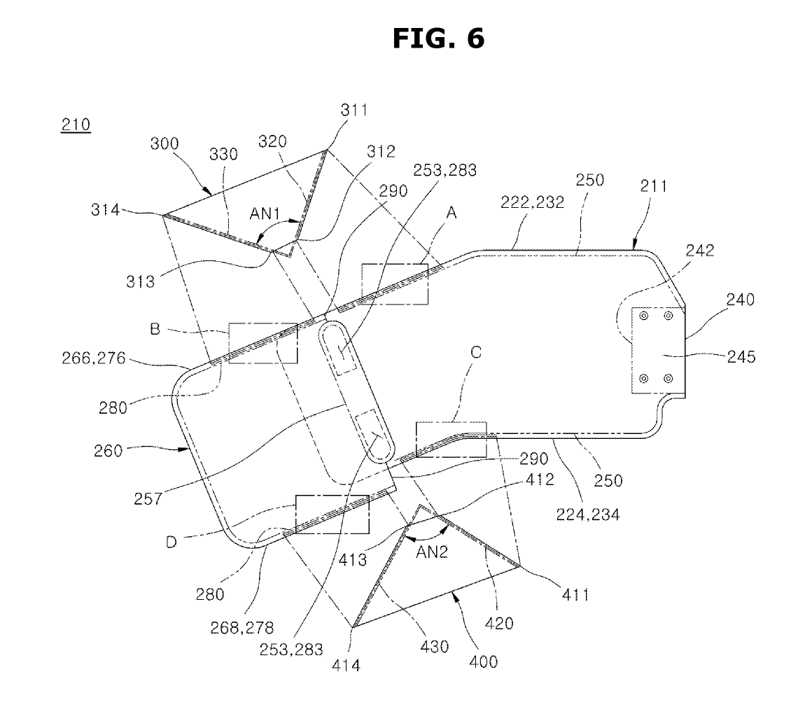

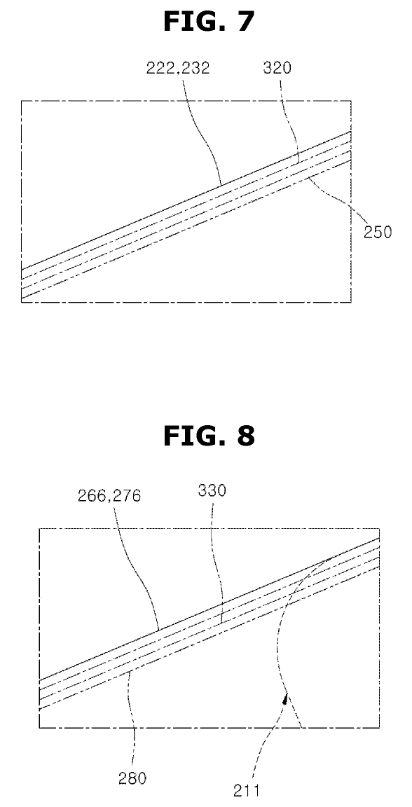

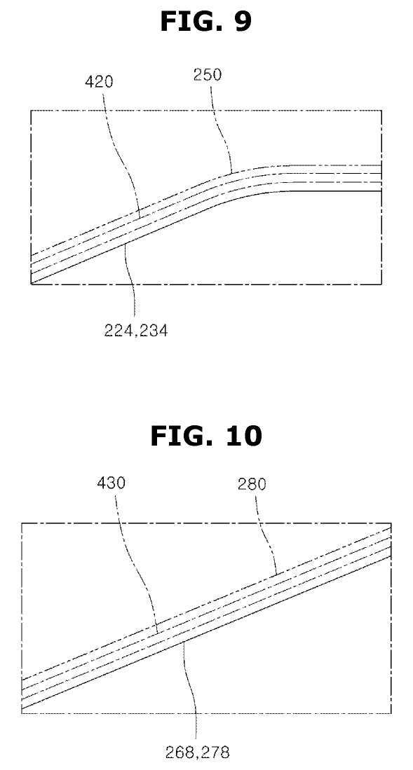

FIG. 1 is a perspective view illustrating a state in which an airbag apparatus according to an embodiment of the present disclosure is deployed to surround an occupant. FIG. 2 is a plan view illustrating a state in which an airbag apparatus according to an embodiment of the present disclosure is deployed to protrude from a seatback as viewed from above. FIG. 3 is a bottom view illustrating a state in which an airbag apparatus according to an embodiment of the present disclosure is deployed as viewed from below. FIG. 4 is a development view illustrating an outer side cushion sheet, an inner side cushion sheet, and a side cushion stitched portion included in a second side cushion of FIG. 2 in an unfolded state. FIG. 5 is a development view illustrating an outer front cushion sheet, an inner front cushion sheet, and a front cushion stitched portion included in a second front cushion of FIG. 2 in an unfolded state. FIG. 6 is a development view illustrating a state in which the second side cushion and the second front cushion included in a second chamber of FIG. 2 are coupled to each other in an uninflated state, and a first surface tether and a second surface tether are separated from the second side cushion and the second front cushion. FIG. 7 is an enlarged view illustrating portion A of FIG. 6. FIG. 8 is an enlarged view illustrating portion B of FIG. 6. FIG. 9 is an enlarged view illustrating portion C of FIG. 6. FIG. 10 is an enlarged view illustrating portion D of FIG. 6.

Referring to FIGS. 1 to 3, an airbag apparatus 100 according to an embodiment of the present disclosure includes a first chamber 110 and a second chamber 210. The airbag apparatus 100 may be a so-called surround airbag apparatus in which the first chamber 110 and the second chamber 210 are deployed to surround an occupant 1 seated on a seat 10 of a vehicle in the event of a vehicle collision. For example, the first chamber 110 and the second chamber 210 may be deployed to surround an upper body 3 of the occupant 1.

The first chamber 110 includes a first side cushion 111 and a first front cushion 160. The second chamber 210 includes a second side cushion 211 and a second front cushion 260. The seat 10 of the vehicle includes a seat stool 11 that supports hips of the occupant 1 and a seatback 20 that supports a back of the occupant 1.

The first side cushion 111 is connected to one side of the seatback 20 and is deployed forward. For example, one side of the seatback 20 may be a left side of the seatback 20. The first front cushion 160 is deployed from the first side cushion 111 to face a front of the occupant 1.

The second side cushion 211 is connected to the other side of the seatback 20 and is deployed forward. For example, the other side of the seatback 20 may be a right side of the seatback 20. The second front cushion 260 is deployed from the second side cushion 211 to overlap the first front cushion 160. For example, the second front cushion 260 may be deployed to be positioned in front of the first front cushion 160.

The airbag apparatus 100 may further include a first inflator 102, a second inflator 202, a first inflator fixing stud 104, and a second inflator fixing stud 204.

The first inflator 102 is positioned inside the first side cushion 111. The first inflator 102 provides gas for deploying the first chamber 110. The first inflator 102 is positioned offset toward a rear end portion rather than a front end portion of the first side cushion 111.

The second inflator 202 is positioned inside the second side cushion 211. The second inflator 202 provides gas for deploying the second chamber 210. The second inflator 202 is positioned offset toward a rear end portion rather than a front end portion of the second side cushion 211.

The first inflator fixing stud 104 may connect the first inflator 102 and the seatback 20 so as to support the first inflator 102 on one side of the seatback 20. The second inflator fixing stud 204 may connect the second inflator 202 and the seatback 20 so as to support the second inflator 202 on the other side of the seatback 20.

The seatback 20 may include a seatback frame 21 and a seatback cover 27 that surrounds the seatback frame 21 to prevent the seatback frame 21 from being exposed. The seatback cover 27 may, for example, be made of fabric or leather. The first inflator fixing stud 104 may connect the first inflator 102 and one side of the seatback frame 21. The second inflator fixing stud 204 may connect the second inflator 202 and the other side of the seatback frame 21.

The undeployed first chamber 110 and the first inflator 102 may be positioned in a space between the inner surface of one side of the seatback cover 27 and the outer surface of one side of the seatback frame 21. The undeployed second chamber 210 and the second inflator 202 may be positioned in a space between the inner surface of the other side of the seatback cover 27 and the outer surface of the other side of the seatback frame 21.

The first chamber 110, which is deployed by gas supplied from the first inflator 102, may partially tear one side of the seatback cover 27 and protrude toward one side of the seatback 20. The second chamber 210, which is deployed by gas supplied from the second inflator 202, may partially tear the other side of the seatback cover 27 and protrude toward the other side of the seatback 20.

When the first side cushion 111 and the second side cushion 211 are deployed, a first side tether 107 may pull the first side cushion 111 by elastic force and a second side tether 207 may pull the second side cushion 211 by elastic force so as to prevent the two side cushions from excessively separating from each other.

The first side tether 107 includes one end portion coupled to one side of the seatback 20 and the other end portion coupled to the first side cushion 111. The second side tether 207 includes one end portion coupled to the other side of the seatback 20 and the other end portion coupled to the second side cushion 211.

One end portion of the first side tether 107 may be coupled to the first inflator fixing stud 104. One end portion of the second side tether 207 may be coupled to the second inflator fixing stud 204.

The airbag apparatus 100 may further include a front cushion coupling portion 500 configured to detachably couple the first front cushion 160 and the second front cushion 260 when the first front cushion 160 and the second front cushion 260 overlap.

For example, the front cushion coupling portion 500 may include a loop tape 510 and a hook tape 520. The loop tape 510 may be fixedly mounted on the surface of the first front cushion 160 facing the second front cushion 260, which is the front surface. The hook tape 520 may be fixedly mounted on the surface of the second front cushion 260 facing the first front cushion 160, which is the rear surface.

In addition, unlike the embodiment illustrated in FIGS. 2 and 3, in an airbag apparatus according to another embodiment of the present disclosure, a hook tape may be fixedly coupled to the first front cushion, and a loop tape may be fixedly coupled to the second front cushion.

Referring to FIGS. 2 to 6, the second side cushion 211 may include an outer side cushion sheet 220, an inner side cushion sheet 230, and a side cushion stitched portion 250. The inner side cushion sheet 230 may be superimposed on the outer side cushion sheet 220.

The side cushion stitched portion 250 couples an outer periphery of the outer side cushion sheet 220 and an outer periphery of the inner side cushion sheet 230. The second side cushion 211 may be formed by superimposing the outer side cushion sheet 220 and the inner side cushion sheet 230, and stitching the outer periphery of the outer side cushion sheet 220 and the outer periphery of the inner side cushion sheet 230 with thread to create an internal space.

The outer side cushion sheet 220 and the inner side cushion sheet 230 may be continuous without being separated. For example, the outer side cushion sheet 220 and the inner side cushion sheet 230 may be positioned on the respective sides of a single foldable flexible panel.

The second side cushion 211 may be formed by folding the flexible panel along a fold line 240, which defines the boundary between the outer side cushion sheet 220 and the inner side cushion sheet 230, so that the outer side cushion sheet 220 and the inner side cushion sheet 230 are superimposed, and stitching the outer periphery of the outer side cushion sheet 220 and the outer periphery of the inner side cushion sheet 230.

The second side cushion 211 may include an inflator mounting panel 245 and an inflator mounting panel stitched portion 242. The inflator mounting panel 245 may be attached to the rear end portions of the outer side cushion sheet 220 and the inner side cushion sheet 230 to prevent the second side cushion 211 from being damaged by the heat and pressure of gas released when the second inflator 202 is activated in the event of a vehicle collision.

The inflator mounting panel stitched portion 242 may be formed by stitching the outer periphery of the inflator mounting panel 245 and the rear end portions of the outer side cushion sheet 220 and the inner side cushion sheet 230 with thread. The second inflator 202 may be mounted inside the inflator mounting panel 245.

The second front cushion 260 may include an inner front cushion sheet 264, an outer front cushion sheet 274, and a front cushion stitched portion 280. The inner front cushion sheet 264 may be superimposed on the outer front cushion sheet 274.

The front cushion stitched portion 280 couples an outer periphery of the outer front cushion sheet 274 and an outer periphery of the inner front cushion sheet 264. The second front cushion 260 may be formed by superimposing the outer front cushion sheet 274 and the inner front cushion sheet 264 and stitching the outer periphery of the outer front cushion sheet 274 and the outer periphery of the inner front cushion sheet 264 with thread.

The outer front cushion sheet 274 and the inner front cushion sheet 264 may be continuous without being separated. For example, the outer front cushion sheet 274 and the inner front cushion sheet 264 may be positioned on the respective sides of a single foldable flexible panel.

The second front cushion 260 may be formed by folding the flexible panel along a fold line 290, which defines the boundary between the outer front cushion sheet 274 and the inner front cushion sheet 264, so that the outer front cushion sheet 274 and the inner front cushion sheet 264 are superimposed, and stitching the outer periphery of the outer front cushion sheet 274 and the outer periphery of the inner front cushion sheet 264 to create an internal space.

A front cushion connecting through-hole 253 may be formed at a front end portion of the inner side cushion sheet 230 so that gas supplied from the second inflator 202 may flow from the internal space of the second side cushion 211 to the internal space of the second front cushion 260.

A side cushion connecting through-hole 283 corresponding to the front cushion connecting through-hole 253 may be formed at a boundary portion between the inner front cushion sheet 264 and the outer front cushion sheet 274 of the second front cushion 260.

A cushion connecting stitched portion 257 couples the second side cushion 211 and the second front cushion 260 such that the front cushion connecting through-hole 253 and the side cushion connecting through-hole 283 are aligned to allow gas flow.

The cushion connecting stitched portion 257 may be formed along a stitch line surrounding the front cushion connecting through-hole 253 and the side cushion connecting through-hole 283. The front cushion connecting through-hole 253 and the side cushion connecting through-hole 283 may be aligned to allow gas flow, and the cushion connecting stitched portion 257 may be formed by stitching along a stitch line surrounding the front cushion connecting through-hole 253 and the side cushion connecting through-hole 283 with thread.

Referring to FIGS. 2, 3 and 6 to 10, the airbag apparatus 100 includes a first surface tether 300. One side of the first surface tether 300 is coupled to the second side cushion 211, and the other side is coupled to the second front cushion 260. The first surface tether 300 is positioned above the first chamber 110 when the first chamber 110 and the second chamber 210 are deployed.

The first surface tether 300 blocks the first front cushion 160 to prevent the upper portion of the first front cushion 160 from extending above the upper portion of the second front cushion 260.

The first surface tether 300 may be made of a flexible and elastic material to allow folding or bending. The planar shape of the first surface tether 300 may, for example, be a quadrilateral having four vertices 311, 312, 313, and 314. Specifically, the planar shape of the first surface tether 300 may be trapezoidal.

For example, among the four vertices, the distance between a first vertex 311 and a fourth vertex 314 may be greater than the distance between a second vertex 312 and a third vertex 313. The edge between the first vertex 311 and the fourth vertex 314 and the edge between the second vertex 312 and the third vertex 313 may be parallel.

In addition, the planar shape of the first surface tether included in an airbag apparatus according to another embodiment of the present disclosure may be, for example, triangular, unlike the shape illustrated in FIG. 6.

One side of the first surface tether 300 may be coupled to the upper portion of the second side cushion 211, and the other side of the first surface tether 300 may be coupled to the upper portion of the second front cushion 260.

The airbag apparatus 100 may further include a first surface tether rear stitched portion 320 and a first surface tether front stitched portion 330. The first surface tether rear stitched portion 320 couples one side of the first surface tether 300 to an outer region of the second side cushion 211, outside the side cushion stitched portion 250. The first surface tether front stitched portion 330 couples the other side of the first surface tether 300 to an outer region of the second front cushion 260, outside the front cushion stitched portion 280.

The first surface tether rear stitched portion 320 may be formed by stitching the first surface tether 300 and the second side cushion 211 with thread, and the first surface tether front stitched portion 330 may be formed by stitching the first surface tether 300 and the second front cushion 260 with thread. In FIGS. 6 to 8, the first surface tether rear stitched portion 320 and the first surface tether front stitched portion 330 are illustrated by a pair of thin dash-dot lines.

As illustrated in FIG. 7, the first surface tether rear stitched portion 320 may be formed in a selvage region between the upper edges 222 and 232 of the outer side cushion sheet 220 and the inner side cushion sheet 230, and the side cushion stitched portion 250. Since the first surface tether rear stitched portion 320 is free from interference with the side cushion stitched portion 250 in this case, a robust first surface tether rear stitched portion 320 may be easily formed.

As illustrated in FIG. 8, the first surface tether front stitched portion 330 may be formed in a selvage region between the upper edges 266 and 276 of the inner front cushion sheet 264 and the outer front cushion sheet 274, and the front cushion stitched portion 280. Since the first surface tether front stitched portion 330 is free from interference with the front cushion stitched portion 280 in this case, a robust first surface tether front stitched portion 330 may be easily formed. In FIGS. 7 and 8, the first surface tether rear stitched portion 320 and the first surface tether front stitched portion 330 are illustrated by a pair of thin dash-dot lines.

Referring to FIGS. 2 and 6 to 8, the distance TFL1 of the first surface tether front stitched portion 330 may range from one-third to one times the length FLE1 of the second front cushion 260.

If the distance TFL1 of the first surface tether front stitched portion 330 is less than one-third of the length FLE1 of the second front cushion 260, only a partial region of the second front cushion 260 to which the first surface tether front stitched portion 330 is coupled is pulled by the first surface tether 300 when the second chamber 210 is deployed, and another region of the second front cushion 260, which is not coupled to the first surface tether front stitched portion 330, may deploy forward of the seat 10 by pressure of gas injected into the internal space of the second front cushion 260.

Accordingly, the second front cushion 260 may bend so as not to be deployed in a straight line along the center line FLI of the second front cushion 260, and the loop tape 510 and the hook tape 520 of the front cushion coupling portion 500 may not be firmly coupled.

In addition, of the two longitudinal ends 313 and 314 of the first surface tether front stitched portion 330, the distance TGP1 between end 313 closer to the second side cushion 211 and the second side cushion 211 may range from zero to one-tenth of the length FLE1 of the second front cushion 260.

The distance TGP1 between the end 313 of the first surface tether front stitched portion 330 and the second side cushion 211 may be the distance between the end 313 and the center line SLI of the second side cushion 211, extended along a longitudinal direction of the second side cushion 211.

If the distance TGP1 between the end 313 of the first surface tether front stitched portion 330 and the second side cushion 211 is greater than one-tenth of the length FLE1 of the second front cushion 260, the second front cushion 260 may bend, as in the case of the distance TFL1 of the first surface tether front stitched portion 330 being less than one-third of the length FLE1 of the second front cushion 260, and the loop tape 510 and the hook tape 520 of the front cushion coupling portion 500 may not be firmly coupled.

The extension line of the first surface tether front stitched portion 330 and the extension line of the first surface tether rear stitched portion 320 may be perpendicular. In other words, an angle AN1 formed by the intersecting extension lines of the first surface tether front stitched portion 330 and the first surface tether rear stitched portion 320 may be 90°.

If the above-described angle AN1 is not 90°, the center line FLI of the second front cushion 260, extended along the longitudinal direction of the second front cushion 260, may be inclined with respect to the center line SLI of the second side cushion 211, rather than being perpendicular. For example, with reference to FIG. 2, the second front cushion 260 may protrude and be deployed at an inclination with respect to the X-axis. Accordingly, the loop tape 510 and the hook tape 520 of the front cushion coupling portion 500 may not be firmly coupled.

The airbag apparatus 100 may further include a second surface tether 400. One side of the second surface tether 400 may be coupled to the second side cushion 211, and the other side may be coupled to the second front cushion 260. The second surface tether 400 is positioned below the first chamber 110 when the first chamber 110 and the second chamber 210 are deployed.

The second surface tether 400 blocks the first front cushion 160 to prevent the lower portion of the first front cushion 160 from extending below the lower portion of the second front cushion 260.

The second surface tether 400 may be made of a flexible and elastic material to allow folding or bending. The planar shape of the second surface tether 400 may, for example, be a quadrilateral having four vertices 411, 412, 413, and 414. Specifically, the planar shape of the second surface tether 400 may be trapezoidal.

For example, among the four vertices, the distance between a first vertex 411 and a fourth vertex 414 may be greater than the distance between a second vertex 412 and a third vertex 413. The edge between the first vertex 411 and the fourth vertex 414 and the edge between the second vertex 412 and the third vertex 413 may be parallel.

In addition, the planar shape of the second surface tether included in an airbag apparatus according to another embodiment of the present disclosure may be, for example, triangular, unlike the shape illustrated in FIG. 6.

One side of the second surface tether 400 may be coupled to the lower portion of the second side cushion 211, and the other side of the second surface tether 400 may be coupled to the lower portion of the second front cushion 260.

The airbag apparatus 100 may further include a second surface tether rear stitched portion 420 and a second surface tether front stitched portion 430. The second surface tether rear stitched portion 420 couples one side of the second surface tether 400 to an outer region of the second side cushion 211, outside the side cushion stitched portion 250. The second surface tether front stitched portion 430 couples the other side of the second surface tether 400 to an outer region of the second front cushion 260, outside the front cushion stitched portion 280.

The second surface tether rear stitched portion 420 may be formed by stitching the second surface tether 400 and the second side cushion 211 with thread, and the second surface tether front stitched portion 430 may be formed by stitching the second surface tether 400 and the second front cushion 260 with thread. In FIGS. 6 to 8, the second surface tether rear stitched portion 420 and the second surface tether front stitched portion 430 are illustrated by a pair of thin dash-dot lines.

As illustrated in FIG. 9, the second surface tether rear stitched portion 420 may be formed in a selvage region between the lower edges 224 and 234 of the outer side cushion sheet 220 and the inner side cushion sheet 230, and the side cushion stitched portion 250. Since the second surface tether rear stitched portion 420 is free from interference with the side cushion stitched portion 250 in this case, a robust second surface tether rear stitched portion 420 may be easily formed.

As illustrated in FIG. 10, the second surface tether front stitched portion 430 may be formed in a selvage region between the lower edges 268 and 278 of the inner front cushion sheet 264 and the outer front cushion sheet 274, and the front cushion stitched portion 280. Since the second surface tether front stitched portion 430 is free from interference with the front cushion stitched portion 280 in this case, a robust second surface tether front stitched portion 430 may be easily formed. In FIGS. 9 and 10, the second surface tether rear stitched portion 420 and the second surface tether front stitched portion 430 are illustrated by a pair of thin dash-dot lines.

Referring to FIGS. 3, 6, 9, and 10, the distance TFL2 of the second surface tether front stitched portion 430 may range from one-third to one times the length FLE of the second front cushion 260.

If the distance TFL2 of the second surface tether front stitched portion 430 is less than one-third of the length FLE of the second front cushion 260, only a partial region of the second front cushion 260 to which the second surface tether front stitched portion 430 is coupled is pulled by the second surface tether 400 when the second chamber 210 is deployed, and another region of the second front cushion 260, which is not coupled to the second surface tether front stitched portion 430, may deploy forward of the seat 10 by pressure of gas injected into the internal space of the second front cushion 260.

Accordingly, the second front cushion 260 may bend so as not to be deployed in a straight line along the center line FLI of the second front cushion 260, and the loop tape 510 and the hook tape 520 of the front cushion coupling portion 500 may not be firmly coupled.

In addition, of the two longitudinal ends 413 and 414 of the second surface tether front stitched portion 430, the distance TGP2 between end 413 closer to the second side cushion 211 and the second side cushion 211 may range from zero to one-tenth of the length FLE of the second front cushion 260.

The distance TGP2 between the end 413 of the second surface tether front stitched portion 430 and the second side cushion 211 may be the distance between the end 413 and the center line SLI of the second side cushion 211, extended along the longitudinal direction of the second side cushion 211.

If the distance TGP2 between the end 413 of the second surface tether front stitched portion 430 and the second side cushion 211 is greater than one-tenth of the length FLE of the second front cushion 260, the second front cushion 260 may bend, as in the case of the distance TFL2 of the second surface tether front stitched portion 330 being less than one-third of the length FLE of the second front cushion 260, and the loop tape 510 and the hook tape 520 of the front cushion coupling portion 500 may not be firmly coupled.

The extension line of the second surface tether front stitched portion 430 and the extension line of the second surface tether rear stitched portion 420 may be perpendicular. In other words, an angle AN2 formed by the intersecting extension lines of the second surface tether front stitched portion 430 and the second surface tether rear stitched portion 420 may be 90°.

If the above-described angle AN2 is not 90°, the center line FLI of the second front cushion 260, extended along the longitudinal direction of the second front cushion 260, may be inclined with respect to the center line SLI of the second side cushion 211, rather than being perpendicular. For example, with reference to FIG. 3, the second front cushion 260 may protrude and be deployed at an inclination with respect to the X-axis. Accordingly, the loop tape 510 and the hook tape 520 of the front cushion coupling portion 500 may not be firmly coupled.

In the airbag apparatus 100 described above, when the first chamber 110 and the second chamber 210 are deployed, the first front cushion 160 and the second front cushion 260 precisely overlap, and the front cushion coupling portion 500 is firmly and reliably coupled to prevent separation of the first chamber 110 and the second chamber 210. Accordingly, in the event of a vehicle collision, the first chamber 110 and the second chamber 210 are prevented from separating, thereby safely restraining the occupant 1 and preventing serious injury to the occupant 1.

Although the present disclosure has been described with reference to an embodiment illustrated in the drawings, this is merely exemplary, and those skilled in the art will understand that various modifications and other equivalent embodiments can be made from this embodiment. Accordingly, the true scope of the present disclosure should be defined only by the appended claims.

What is claimed is:

1. An airbag apparatus, comprising:
a first chamber including a first side cushion connected to a first side of a seatback included in a vehicle seat and configured to be deployed forward, and a first front cushion configured to be deployed from the first side cushion to face a front of an occupant;
a second chamber including a second side cushion connected to a second side of the seatback and configured to be deployed forward, and a second front cushion configured to be deployed from the second side cushion in front of the first front cushion so as to overlap the first front cushion; and
a first surface tether configured to have a first side coupled to the second side cushion and a second side coupled to the second front cushion, and be positioned above the first chamber when the first chamber and the second chamber are deployed.

2. The airbag apparatus of claim 1, wherein the first side of the first surface tether is coupled to an upper portion of the second side cushion, and the second side of the first surface tether is coupled to an upper portion of the second front cushion.

3. The airbag apparatus of claim 2, wherein
the second side cushion includes an outer side cushion sheet, an inner side cushion sheet superimposed on the outer side cushion sheet, and a side cushion stitched portion that couples an outer periphery of the outer side cushion sheet and an outer periphery of the inner side cushion sheet,
the second front cushion includes an outer front cushion sheet, an inner front cushion sheet superimposed on the outer front cushion sheet, and a front cushion stitched portion that couples an outer periphery of the outer front cushion sheet and an outer periphery of the inner front cushion sheet, and
wherein the airbag apparatus further comprises:
a first surface tether rear stitched portion that couples an outer region of the second side cushion, outside the side cushion stitched portion, and the first side of the first surface tether; and
a first surface tether front stitched portion that couples an outer region of the second front cushion, outside the front cushion stitched portion, and the second side of the first surface tether.

4. The airbag apparatus of claim 3, wherein a length of the first surface tether front stitched portion ranges from one-third to one times a length of the second front cushion.

5. The airbag apparatus of claim 1, wherein a planar shape of the first surface tether is triangular or trapezoidal.

6. The airbag apparatus of claim 1, further comprising:
a second surface tether configured to have a first side coupled to the second side cushion and a second side coupled to the second front cushion, be positioned spaced apart from the first surface tether, and be positioned below the first chamber when the first chamber and the second chamber are deployed.

7. The airbag apparatus of claim 6, wherein the first side of the second surface tether is coupled to a lower portion of the second side cushion, and the second side of the second surface tether is coupled to a lower portion of the second front cushion.

8. The airbag apparatus of claim 7, wherein
the second side cushion includes an outer side cushion sheet, an inner side cushion sheet superimposed on the outer side cushion sheet, and a side cushion stitched portion that couples an outer periphery of the outer side cushion sheet and an outer periphery the inner side cushion sheet,
the second front cushion includes an outer front cushion sheet, an inner front cushion sheet superimposed on the outer front cushion sheet, and a front cushion stitched portion that couples an outer periphery of the outer front cushion sheet and an outer periphery the inner front cushion sheet, and
wherein the airbag apparatus further comprises:
a second surface tether rear stitched portion that couples an outer region of the second side cushion, outside the side cushion stitched portion, and the first side of the second surface tether; and
a second surface tether front stitched portion that couples an outer region of the second front cushion, outside the front cushion stitched portion, and the second side of the second surface tether.

9. The airbag apparatus of claim 8, wherein a length of the second surface tether front stitched portion ranges from one-third to one times a length of the second front cushion.

10. The airbag apparatus of claim 6, wherein a planar shape of the second surface tether is triangular or trapezoidal.
